(19) United States
(12) Patent Application Publication
(10) Pub. No.: US 2022/0376564 A1
(43) Pub. Date: Nov. 24, 2022

(54) MOTOR

(71) Applicant: LG INNOTEK CO., LTD., Seoul (KR)

(72) Inventor: Bong Geon KIM, Seoul (KR)

(21) Appl. No.: 17/754,364

(22) PCT Filed: Sep. 28, 2020
(86) PCT No.: PCT/KR2020/013261

§ 371 Date: Mar. 30, 2022

(30) Foreign Application Priority Data
Sep. 30, 2019 (KR) 10-2019-0120847

(51) Int. Cl. H02K 1/14

(52) U.S. Cl. CPC H02K 1/146

(57) ABSTRACT

The present invention may provide a motor including a rotor, a stator disposed to correspond to the rotor, and a housing disposed outside the stator, wherein the stator includes a stator core, an insulator disposed on the stator core, and a coil disposed around the insulator, the stator core includes a yoke and a tooth connected to the yoke, the yoke includes one surface, a first protrusion protruding from the one surface of the yoke, and a first groove formed in the one surface of the yoke, the housing includes the other surface facing the one surface of the yoke, a second protrusion protruding from the other surface of the housing, and a second groove formed in the other surface of the housing, at least a part of the first protrusion is disposed in the second groove, and a predetermined gap is formed between the one surface of the yoke and the other surface of the housing.

### TECHNICAL FIELD

The present invention relates to a motor.

### BACKGROUND ART

A motor includes a rotor and a stator. The stator is disposed outside the rotor. The rotor and the stator are accommodated in a housing. There is a hot-pressing method as a method of fixing the stator and the housing. The hot-pressing method is a method of heating the housing to expand the housing in a radial direction and temporarily increase a diameter of the housing, and inserting the stator into the housing so that, when the housing is cooled, the housing returns to its original state and the diameter of the housing decreases to press the stator inward and fix the stator to the housing.

However, when the stator is fixed to the housing through the hot-pressing method, since a contraction force of the housing varies partially when the housing contracts, an inner circumferential surface of teeth of the stator may not form a perfect circle, and thus the teeth may be misarranged. When the teeth are misarranged, a problem of increasing a cogging torque occurs.

### Technical Problem

The present invention is directed to providing a motor capable of preventing slip occurring between a housing and a stator while securing a perfect circle of teeth of the stator.

Objectives to be solved by the present invention are not limited to the above-described objectives, and other objectives which are not described above will be clearly understood by those skilled in the art from the following specification.

### Technical Solution

One aspect of the present invention provides a motor including a rotor, a stator disposed to correspond to the rotor, and a housing disposed outside the stator, wherein the stator includes a stator core, an insulator disposed on the stator core, and a coil disposed around the insulator, the stator core includes a yoke and a tooth connected to the yoke, the yoke includes one surface, a first protrusion protruding from the one surface of the yoke, and a first groove formed in the one surface of the yoke, the housing includes the other surface facing the one surface of the yoke, a second protrusion protruding from the other surface of the housing, and a second groove formed in the other surface of the housing, at least a part of the first protrusion is disposed in the second groove, and a predetermined gap is formed between the one surface of the yoke and the other surface of the housing.

Another aspect of the present invention provides a motor including a rotor, a stator disposed to correspond to the rotor, and a housing disposed outside the stator, wherein the stator includes a stator core, an insulator disposed on the stator core, and a coil disposed around the insulator, the stator core includes a yoke and a tooth connected to the yoke, the yoke includes one surface, a first protrusion protruding from the one surface of the yoke, and a first groove formed in the one surface of the yoke, the housing includes the other surface facing the one surface of the yoke, a second protrusion protruding from the other surface of the housing, and the second groove formed in the other surface of the housing, at least a part of the first protrusion is disposed in the second groove, and one surface of the first protrusion and one surface of the first groove are connected to each other.

Still another aspect of the present invention provides a motor including a rotor, a stator disposed to correspond to the rotor, and a housing disposed outside the stator, wherein the stator includes a stator core, an insulator disposed on the stator core, and a coil disposed around the insulator, the stator core includes a yoke and a tooth connected to the yoke, the yoke includes an outer circumferential surface, a first protrusion protruding from the outer circumferential surface of the yoke, and a first groove formed in the outer circumferential surface of the yoke, the housing includes an inner circumferential surface facing the outer circumferential surface of the yoke, a second protrusion protruding from the inner circumferential surface of the housing, and a second groove formed in the inner circumferential surface of the housing, and at least a part of the first protrusion is disposed in the second groove.

A width of the first protrusion in a circumferential direction may be in the range of 150% to 170% of a width of the second groove in the circumferential direction.

One surface of the first protrusion may be in contact with one surface of the second protrusion.

At least a part of the second protrusion may be disposed in the first groove.

A volume of the second groove and a volume of the second protrusion may be the same, and a volume of the first groove and a volume of the first protrusion may be the same.

The housing may include a third protrusion protruding from an inner surface of the housing, and the second groove may be disposed between the second protrusion and the third protrusion in a circumferential direction.

A volume of the second groove may be the same as a sum of a volume of the second protrusion and a volume of the third protrusion.

A height from a lowest point of the second groove to a highest point of the second protrusion may be higher than a height of the first protrusion.

The height from the lowest point of the second groove to the highest point of the second protrusion may be lower than the height of the first protrusion.

A part of the first protrusion and a part of the second protrusion may be in contact with each other.

One surface of the first protrusion and one surface of the first groove may be coplanar with each other.

One surface of the second protrusion and one surface of the second groove may be coplanar with each other.

The one surface of the first protrusion may be in contact with the one surface of the second protrusion.

Yet another aspect of the present invention provides a motor including a rotor, a stator disposed to correspond to the rotor, and a housing disposed outside the stator, wherein the stator includes a stator core, an insulator disposed on the stator core, and a coil disposed around the insulator, the stator core includes a yoke and a tooth connected to the yoke, the yoke includes one surface, first protrusions protruding from the one surface of the yoke, and first grooves formed in the one surface of the yoke, the housing includes the other surface facing the one surface of the yoke and a stepped portion protruding from the other surface of the housing, and the stepped portion includes a third groove in which at least a part of the first protrusion is disposed.

The yoke may include a groove at a position overlapping the tooth in a radial direction, and the first protrusions and the first grooves may be disposed at one side or both sides of the groove.

The first protrusions and the first grooves may be disposed at both sides of the groove and may have the same distances from the groove.

The first protrusions and the first grooves may be disposed closer to the groove than one side of the yoke.

### Advantageous Effects

According to embodiments, since a perfect circle of an inner circumferential surface of teeth of a stator is secured, there is an advantage of decreasing a cogging torque.

According to the embodiments, there is an advantage of coupling a stator to a housing without using a hot-pressing method.

According to the embodiments, there is an advantage of preventing slip occurring between the housing and the stator.

### DESCRIPTION OF DRAWINGS

FIG. 1 is a view illustrating a motor according to an embodiment.

FIGS. 2 to 4 are views illustrating a stator core.

FIG. 5 is a plan view illustrating the stator core and a housing.

FIG. 6 is an enlarged view illustrating a first protrusion, a first groove, a second protrusion, and a second groove.

FIG. 7 is an enlarged view illustrating a state in which the second protrusion is not inserted into the first groove.

FIG. 8 is an enlarged view illustrating a state in which the second protrusion is inserted into the first groove.

FIG. 9 is an enlarged view illustrating a third protrusion of the housing.

FIG. 10 is a view illustrating a stepped portion of the housing.

FIG. 11 is an enlarged view illustrating a state in which one surface of a yoke is pressed against the other surface of the housing.

FIG. 12 is a view illustrating the stator core in a radial direction.

FIG. 13 is a view illustrating the stator core in the radial direction, which shows a plurality of first protrusions and first grooves disposed to be divided in a height direction of a tooth to correspond to one tooth.

FIG. 14 is a view illustrating the stator core in the radial direction, which shows a plurality of first protrusions and first grooves disposed to be divided on the basis of a center of the tooth in a circumferential direction to correspond to one tooth.

FIG. 15 is a view illustrating the stator core in the radial direction, which shows a plurality of first protrusions and first grooves disposed to be divided on the basis of the center in the circumferential direction and a center in the height direction of the tooth to correspond to one tooth.

FIG. 16 is a view illustrating the stator core from the side, which shows an upper end portion of the first protrusion.

### MODES OF THE INVENTION

Hereinafter, exemplary embodiments of the present invention will be described in detail with reference to the accompanying drawings.

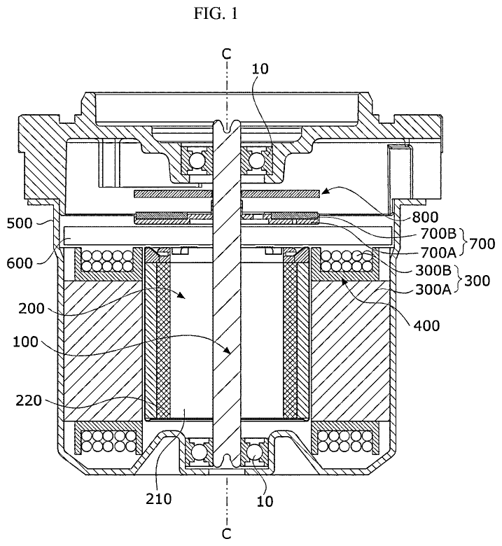

FIG. 1 is a view illustrating a motor according to an embodiment.

Referring to FIG. 1, the motor according the present invention may include a rotary shaft 100, a rotor 200, a stator 300, insulators 400, a housing 500, a busbar 600, a sensing unit 700, and a substrate 800. Hereinafter, the term “inward” refers to a direction from the housing 500 toward the rotary shaft 100 which corresponds to a center of the motor, and the term “outward” refers to a direction from the rotary shaft 100 toward the housing 500 that is an opposite direction of “inward.” In addition, hereinafter, a circumferential direction and a radial direction are each defined based one an axial center.

The rotary shaft 100 may be coupled to the rotor 200. When a current is supplied and an electromagnetic interaction occurs between the rotor 200 and the stator 300, the rotor 200 rotates, and the rotary shaft 100 rotates in conjunction with the rotation of the rotor 200. The rotary shaft 100 is rotatably supported by the bearings 10. The rotary shaft 100 may be connected to a steering device of a vehicle and may supply power to the steering device.

The rotor 200 is rotated due to an electrical interaction with the stator 300. The rotor 200 may be disposed inside the stator 300. The rotor 200 may include a rotor core 210 and magnets 220 disposed on the rotor core 210. In this case, the rotor 200 may be a surface permanent magnet (SPM) type rotor in which the magnets 220 are disposed on an outer circumferential surface of the rotor core 210 or an inner permanent magnet (IPM) type rotor in which the magnets 220 are buried inside the rotor core 210.

The stator 300 is disposed outside the rotor 200. The stator 300 may include a stator core 300A, coils 300B, and the insulators 400 installed on the stator core 300A. The coils 300B may be wound around the insulators 400. The insulators 400 are disposed between the coils 300B and the stator core 300A to serve to electrically insulate the stator core 300A from the coils 300B. The coils 300B induce electrical interactions with the magnets of the rotor 200.

The housing 500 accommodates the rotor 200 and the stator 300 therein.

The busbar 600 is disposed above the stator 300. The busbar 600 includes a busbar holder (not shown) formed of an insulation material and a plurality of terminals (not shown) coupled to the busbar holder. In this case, the busbar holder is formed of the insulation material to prevent the plurality of terminals from being connected to each other. In addition, the plurality of terminals connect the coils 300B wound around the stator core 300A to each other to serve to apply current to the coils.

The sensing unit 700 may be coupled to the rotary shaft 100. The sensing unit 700 includes a sensing plate 700A and a sensing magnet 700B disposed above the sensing plate 700A. A sensor which detects a magnetic force of the sensing magnet 700B may be disposed on the substrate 800. In this case, the sensor may be a Hall integrated circuit (IC) and serves to detect a magnetic flux of the sensing magnet of the sensing unit 700 coupled to the rotary shaft 100. The sensing unit 700 and the substrate 800 serve to detect a position of the rotor 200 by detecting the magnetic flux which varies according to rotation.

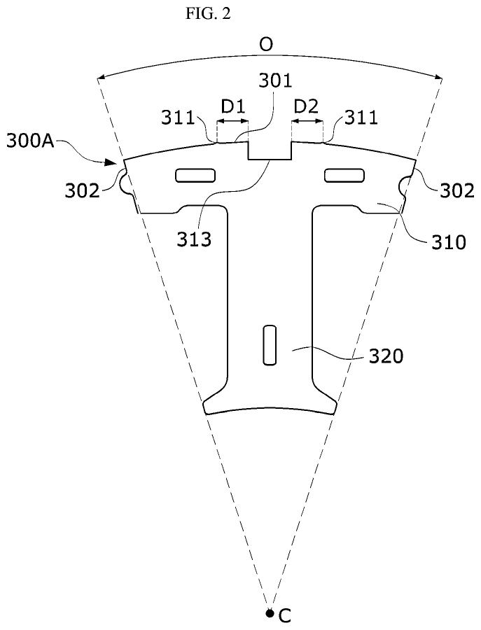

FIGS. 2 to 4 are views illustrating the stator core 300A.

Referring to FIGS. 2 to 4, the stator core 300A may include yokes 310 and teeth 320. The teeth 320 may protrude from an inner circumferential surface of the yokes 310. The plurality of teeth 320 may be provided. The number of teeth 320 may vary to correspond to the number of the magnets. The stator core 300A may be formed by combining a plurality of divided cores, which include the yokes 310 and the teeth 320.

The stator core 300A includes first protrusions 311 and first grooves 312 provided as pairs. The first protrusions 311 and the first grooves 312 are for coupling the stator core 300A and the housing 500. A hardness of a material forming the stator core 300A may be higher than a hardness of a material forming the housing 500. For example, the stator core 300A may be formed of iron, and the housing 500 may be formed of aluminum having a lower hardness than iron. Accordingly, in a process in which the stator 300 is press-fitted into the housing 500, the first protrusions 311 penetrate into an inner surface of the housing 500 to physically couple the stator 300 and the housing 500. The first grooves 312 are spaces into which portions of the inner surface of the housing 500, which is pushed and deformed while the first protrusions 311 penetrate the inner surface of the housing 500, are pushed.

The first protrusions 311 and the first grooves 312 may be formed through a press or skiving process. One surfaces of the first protrusions 311 and one surfaces of the first grooves 312 may be disposed coplanar with each other.

In the process in which the stator 300 is press-fitted into the housing 500, since the first protrusion 311 scratches and passes the inner surface of the housing 500, a straight distance from a center of the stator 300 to an end of the first protrusion 311 in a radial direction of the stator 300 is at least greater than an inner diameter of the housing 500. For example, in consideration of a difference in coefficient of thermal expansion between the stator core 300A formed of iron and the housing 500 formed of aluminum, a size of the first protrusion 311 may be determined so that the straight distance to the end of the first protrusion 311 therefrom is at least greater than the inner diameter of the housing 500 at a temperature of about 150°.

The first protrusion 311 may be disposed to protrude outward from one surface 301 of the yoke 310. The first groove 312 may be concavely disposed inward from the one surface 301 of the yoke 310. In this case, the one surface 301 may be an outer circumferential surface of the yoke 310. In a circumferential direction of the stator 300, the first protrusion 311 and the first groove 312 may be consecutively disposed to form one pair. For example, one surface of the first protrusion 311 may be connected to one surface of the first groove 312.

A groove 313 may be disposed in the one surface 301 of the yoke 310. The groove 313 is a groove for securing a separation space between the yoke 310 and the inner surface of the housing 500. The groove 313 may be disposed in a region O overlapping the tooth 320 in the radial direction about a stator center C.

The first protrusion 311 and the first groove 312 may be disposed at one side or both sides of the groove 313 in the circumferential direction. When the first protrusions 311 and the first grooves 312 are disposed at both sides of the groove 313, a distance D1 between the protrusion 311 and the first groove 312, which are disposed at one side of the groove 313, and the groove 313 in the circumferential direction may be the same as a distance D2 between the first protrusion 311 and the first groove 312, which are disposed at the other side of the groove 313, and the groove 313 in the circumferential direction.

The first protrusions 311 and the first grooves 312 may be disposed closer to the groove 313 than one sides 302 of the yoke 310 in the circumferential direction. In addition, the first protrusions 311 and the first grooves 312 may be disposed closer to a width center of the yoke 310 in the circumferential direction. This is because a length of the stator core 300A in the radial direction is long around the width center of yoke 310 in the circumferential direction, and thus sufficient sizes of the first protrusions 311 and the first grooves 312 may be secured.

As illustrated in FIG. 2, the first protrusion 311 and the first groove 312 may be disposed between the one side 302 of the yoke 310 and the groove 313.

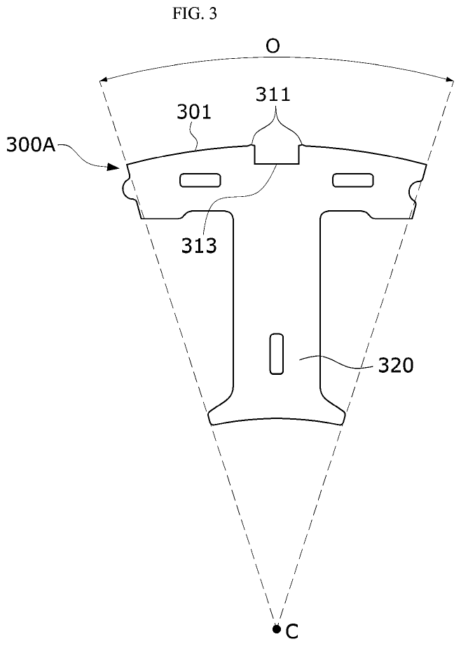

Alternatively, as illustrated in FIG. 3, the first protrusions 311 and the first grooves 312 may be disposed close to both sides of the groove 313. Alternatively, the groove 313 of the yoke 310 may serve functions of the first grooves 312 instead of the first grooves 312 being separately formed. For example, deformed portions of the inner surface of the housing 500 may be pushed into the groove 313.

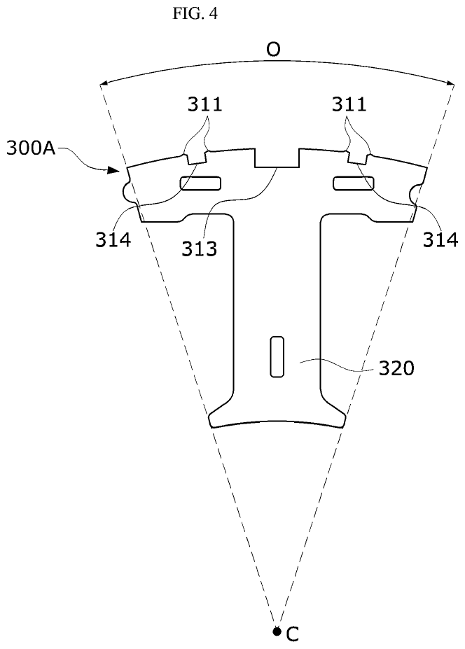

Alternatively, as illustrated in FIG. 4, another plurality of grooves 314 may be disposed in the one surface 301 of the yoke 310, and the first protrusions 311 and the first grooves 312 may be disposed close to both sides of the plurality grooves 314. Alternatively, the plurality of grooves 314 of the yoke 310 may serve functions of the first grooves 312 instead of the first grooves 312 being formed. For example, deformed portions of the inner surface of the housing 500 may be pushed into the plurality of grooves 314.

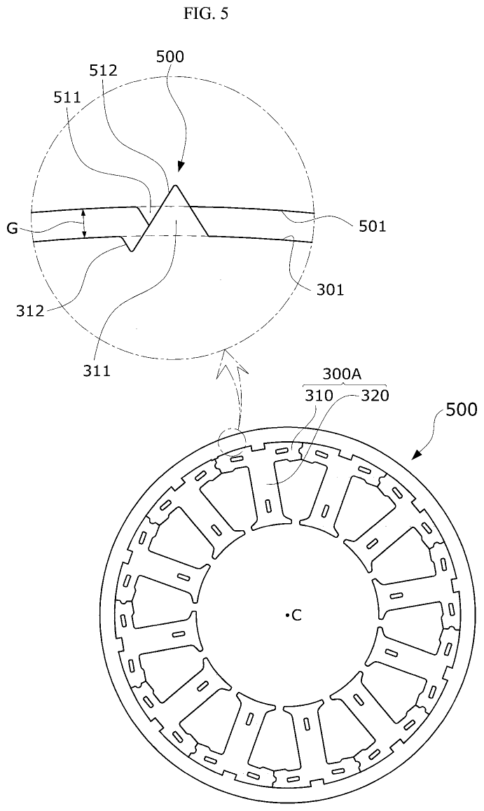

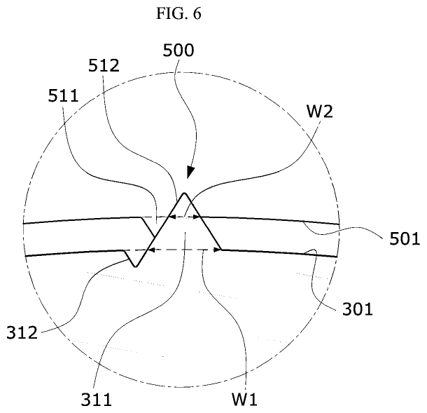

FIG. 5 is a plan view illustrating the stator core 300A and the housing 500, and FIG. 6 is an enlarged view illustrating the first protrusion, the first groove, a second protrusion, and a second groove.

Referring to FIGS. 5 and 6, in the process in which the stator 300 is press-fitted into the housing 500, the first protrusion 311 scratches and passes the other surface 501 of the housing 500. While the first protrusion 311 penetrates into the other surface 501 of the housing 500, the other surface 501 of the housing 500 is deformed and pushed by the first protrusion 311.

Based on the housing 500, hereinafter, a region concavely recessed by the first protrusion 311 is referred to as a second groove 512, and a region that is deformed and pushed by the first protrusion 311 and convexly protrudes toward the one surface 301 of the yoke 310 is referred to as a second protrusion 511. One surface of the second protrusion 511 and one surface of second groove 512 may be disposed to be coplanar with each other.

A volume of the second groove 512 may be the same as a volume of the second protrusion 511. In addition, a volume of the first groove 312 may be the same as a volume of the first protrusion 311.

In the process in which the stator 300 is press-fitted into the housing 500, the first protrusion 311 is disposed in the second groove 512, the second protrusion 511 is formed, one surface of the second protrusion 511 is in contact with one surface of the first protrusion 311, and thus the housing 500 and the stator 300 are physically coupled. Accordingly, there is an advantage of fixing the stator 300 to the housing 500 even without using a hot press method through which a cogging torque is increased due to a difference in contraction force.

Particularly, since a structure in which the first protrusion 311 penetrates into the other surface 501 of the housing 500 and the second protrusion 511 is inserted into the one surface 301 of the yoke 310 is provided, slip occurring between the stator 300 and the housing 500 can be prevented.

Meanwhile, the one surface 301 of the yoke 310 excluding the first protrusion 311 and the first groove 312 may be formed with a gap G interposed between the one surface 301 of the yoke 310 and the other surface 501 of the housing 500.

Referring to FIG. 6, a width W1 of the first protrusion 311 in the circumferential direction may be in the range of 150% to 170% of a width W2 of the second groove 512 in the circumferential direction. The width W1 of the first protrusion 311 in the circumferential direction is defined based on the one surface 301 of the yoke 310, and the width W2 of the second protrusion 511 in the circumferential direction is defined based on the other surface 501 of the housing 500.

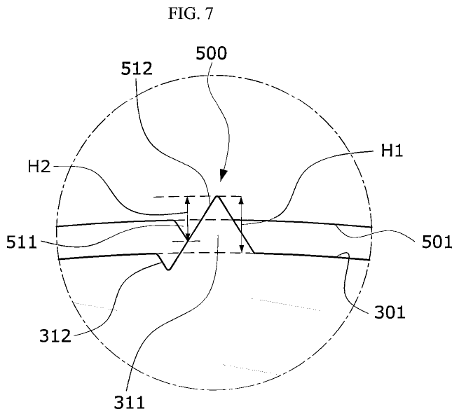

FIG. 7 is an enlarged view illustrating a state in which the second protrusion is not inserted into the first groove.

Referring to FIG. 7, the second protrusion 511 may not be inserted into the first groove 312. Accordingly, a height H2 from a lowest point of the second groove 512 to a highest point of the second protrusion 511 may be lower than a height H1 of the first protrusion 311 based on the one surface 301 of the yoke 310.

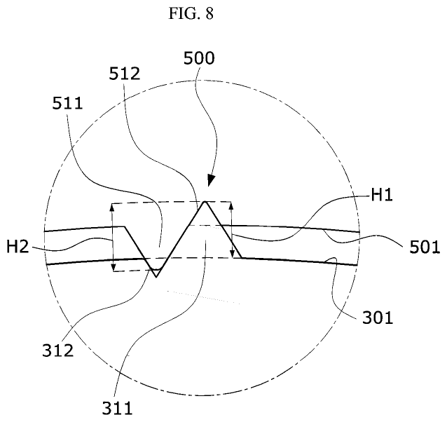

FIG. 8 is an enlarged view illustrating a state in which the second protrusion is inserted into the first groove.

Referring to FIG. 8, the second protrusion 511 may be inserted into the first groove 312. Accordingly, the height H2 from the lowest point of the second groove 512 to the highest point of the second protrusion 511 may be greater than the height H1 of the first protrusion 311 based on the one surface 301 of the yoke 310.

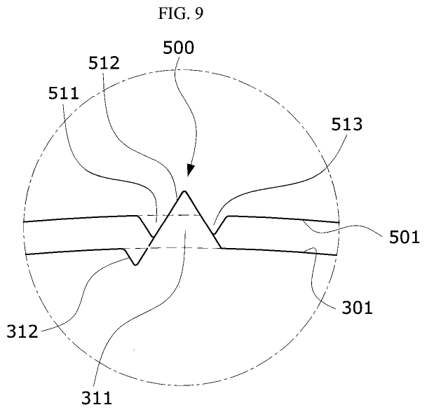

FIG. 9 is an enlarged view illustrating a third protrusion of the housing.

Referring to FIG. 9, the housing 500 may include a third protrusion 513 protruding from the other surface 501 of the housing 500. In the process in which the stator 300 is press-fitted into the housing 500, while the first protrusion 311 penetrates into the inner surface of the housing 500, a portion of the other surface 501 of the housing 500 deformed by the first protrusion 311 and pushed to one side of the first protrusion 311 is the second protrusion 511, and a portion thereof pushed to the other side of the first protrusion 311 is the third protrusion 513.

Accordingly, the second groove 512 may be disposed between the second protrusion 511 and the third protrusion 513. Since the second protrusion 511 and the third protrusion 513 are engaged with the first protrusion 311 at both sides of the first protrusion 311, slip occurring between the stator 300 and the housing 500 can be effectively prevented.

Meanwhile, the volume of the second groove 512 may be the same as the sum of the volume of the second protrusion 511 and a volume of the third protrusion 513.

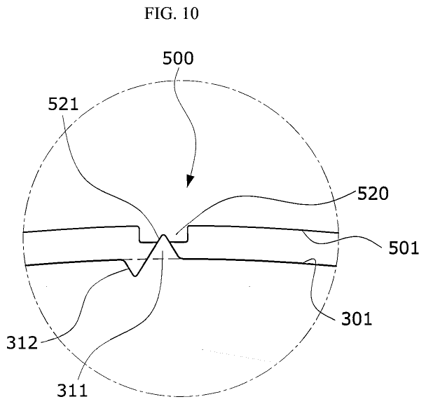

FIG. 10 is a view illustrating a stepped portion 520 of the housing 500.

Referring to FIG. 10, the housing 500 may include the stepped portion 520 protruding from the other surface 501. The stepped portion 520 is a portion which comes into contact with the first protrusion 311 in the process in which the stator 300 is press-fitted into the housing 500. While the first protrusion 311 scratches and passes the stepped portion 520, a third groove 521 is formed in the stepped portion 520. The first protrusion 311 is disposed in the third groove 521.

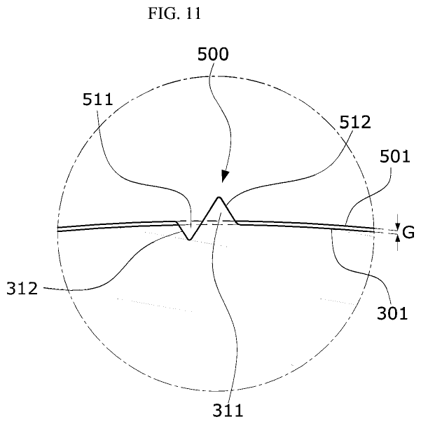

FIG. 11 is an enlarged view illustrating a state in which the one surface 301 of the yoke 310 is pressed against the other surface 501 of the housing 500.

Referring to FIG. 11, when the stator 300 is press-fitted into the housing 500, the one surface 301 of the yoke 310 may be pressed against the other surface 501 of the housing 500 with a minimum gap G therebetween. In this case, the second protrusion 511 may be completely inserted into the first groove 312.

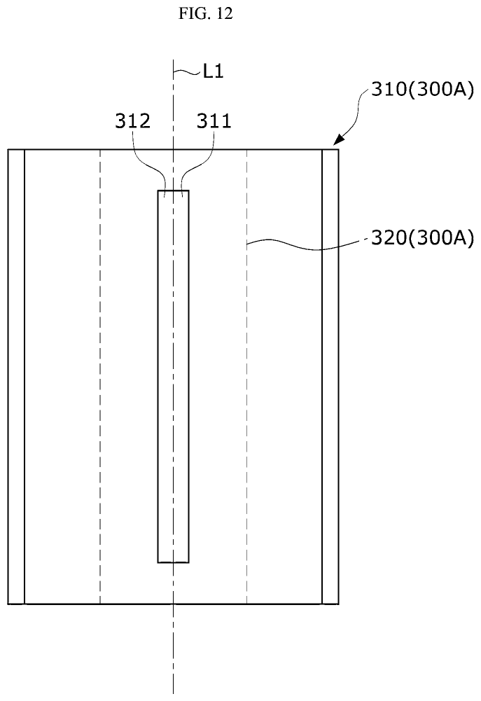

FIG. 12 is a view illustrating the stator core 300A in the radial direction.

Referring to FIG. 12, the first protrusion 311 and the first groove 312 may be disposed to extend in a height direction of the stator 300. In addition, the first protrusion 311 and the first groove 312 may be disposed along a first reference line L1 indicating a center of the tooth 320 in the circumferential direction.

The plurality of first protrusions 311 and the plurality of first grooves 312 may be disposed. The plurality of first protrusions 311 and the plurality of first grooves 312 may be disposed to be rotationally symmetrical with respect to a center C of the stator 300. When the plurality of first protrusions 311 and the plurality of first grooves 312 are disposed to be rotationally symmetrical with respect to the center C of the stator 300, a perfect circle of an inner circumferential surface of the teeth 320 can be easily formed, and the center C of the stator 300 and a center C of the rotary shaft 100 can be aligned.

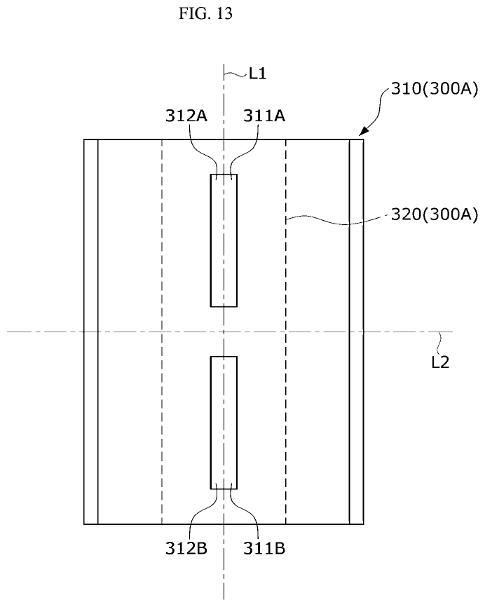

FIG. 13 is a view illustrating the stator core 300A in the radial direction, which shows the plurality of first protrusions and first grooves disposed to be divided in a height direction of the tooth 320 to correspond to one tooth 320.

Referring to FIG. 13, the plurality of first protrusions 311 and first grooves 312 may be disposed to be divided by a second reference line L2 indicating a center C of the tooth 320 in the height direction. For example, a 1-1 protrusion 311A and a 1-1 groove 312A may be disposed at an upper side of the second reference line L2. In addition, a 1-2 protrusion 311B and a 1-2 groove 312B may be disposed at a lower side of the second reference line L2. In this case, the 1-1 protrusion 311A and 1-1 groove 312A and the 1-2 protrusion 311B and 1-2 groove 312B may be symmetrically disposed with respect to the second reference line L2.

Meanwhile, the 1-1 protrusion 311A and 1-1 groove 312A and the 1-2 protrusion 311B and 1-2 groove 312B may be disposed to be aligned with each other along the first reference line L1. However, the present invention is not limited thereto, and the 1-1 protrusion 311A and 1-1 groove 312A and the 1-2 protrusion 311B and 1-2 groove 312B may be disposed to be misaligned with each other in a circumferential direction of the tooth 320.

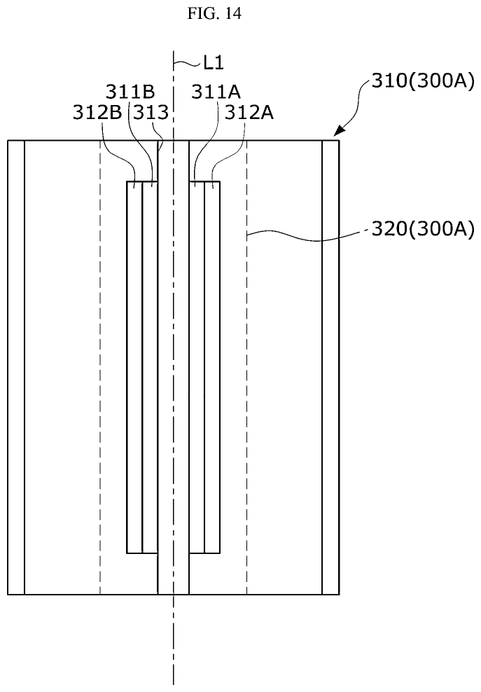

FIG. 14 is a view illustrating the stator core 300A in the radial direction, which shows the plurality of first protrusions 311 and first grooves 312 disposed to be divided on the basis of a center C of the tooth 320 in the circumferential direction to correspond to one tooth 320.

Referring to FIG. 14, the plurality of first protrusions 311 and first grooves 312 may be disposed to be divided by the first reference line L1. For example, the 1-1 protrusion 311A and the 1-1 groove 312A may be disposed at a right side of the first reference line L1. In addition, the 1-2 protrusion 311B and the 1-2 groove 312B may be disposed at a left side of the first reference line L1. In this case, the 1-1 protrusion 311A and 1-1 groove 312A and the 1-2 protrusion 311B and 1-2 groove 312B may be symmetrically disposed with respect to the first reference line L1.

The groove 313 may be disposed between the 1-1 protrusion 311A and 1-1 groove 312A and the 1-2 protrusion 311B and 1-2 groove 312B.

Meanwhile, the 1-1 protrusion 311A may be disposed closer to the first reference line L1 than the 1-1 groove 312A. In addition, the 1-2 protrusion 311B may also be disposed closer to the first reference line L1 than the 1-2 groove 312B.

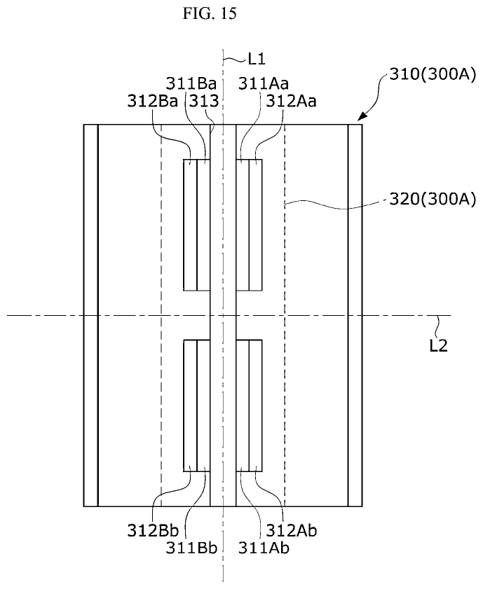

FIG. 15 is a view illustrating the stator core 300A in the radial direction, which shows the plurality of first protrusions 311 and first grooves 312 disposed to be divided on the basis of the center C in the circumferential direction and the center C in the height direction of the tooth 320 to correspond to one tooth 320.

Referring to FIG. 15, the plurality of first protrusions 311 and first grooves 312 may be disposed to be divided by the first reference line L1.

For example, a 1-1-1 protrusion 311Aa, a 1-1-1 groove 312Aa, a 1-1-2 protrusion 311Ab, and a 1-1-2 groove 312Ab may be disposed at the right side of the first reference line L1. In addition, a 1-2-1 protrusion 311Ba, a 1-2-1 groove 312Ba, a 1-2-2 protrusion 311Bb, and a 1-2-2 groove 312Bb may be disposed at the left side of the first reference line L1.

In this case, the 1-1-1 protrusion 311Aa and 1-1-1 groove 312Aa and the 1-2-1 protrusion 311Ba and 1-2-1 groove 312Ba may be symmetrically disposed with respect to the first reference line L1. In addition, the 1-1-2 protrusion 311Ab and 1-1-2 groove 312Ab and the 1-2-2 protrusion 311Bb and 1-2-2 groove 312Bb may be symmetrically disposed with respect to the first reference line L1.

In addition, the plurality of first protrusions 311 and first grooves 312 may be disposed to be divided by the second reference line L2.

For example, the 1-1-1 protrusion 311Aa, the 1-1-1 groove 312Aa, the 1-2-1 protrusion 311Ba, and the 1-2-1 groove 312Ba may be disposed at the upper side of the second reference line L2.

In addition, the 1-1-2 protrusion 311Ab, the 1-1-2 groove 312Ab, the 1-2-2 protrusion 311Bb, and the 1-2-2 groove 312Bb may be disposed at the lower side of the second reference line L2.

In this case, the 1-1-1 protrusion 311Aa and 1-1-1 groove 312Aa and the 1-1-2 protrusion 311Ab and 1-1-2 groove 312Ab may be symmetrically disposed with respect to the second reference line L2. In addition, the 1-2-1 protrusion 311Ba and 1-2-1 groove 312Ba and the 1-2-2 protrusion 311Bb and 1-2-2 groove 312Bb may be symmetrically disposed with respect to the second reference line L2.

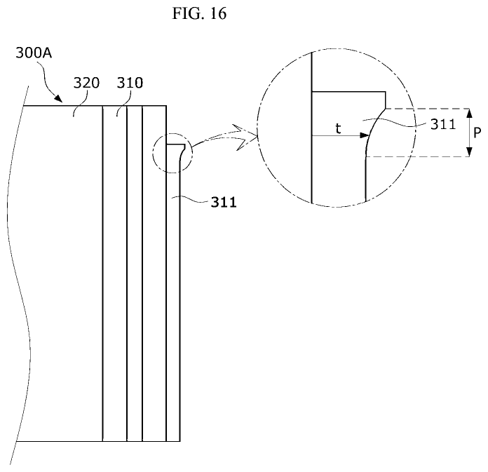

FIG. 16 is a view illustrating the stator core 300A from the side, which shows an upper end portion of the first protrusion 311.

Referring to FIG. 16, the first protrusion 311 may include a region P of which a height t varies. For example, the first protrusion 311 may include the region P of which the height t increases toward the upper side. When it is assumed that the stator 300 is press-fitted into the housing 500 in a direction from top to bottom, the region P may be disposed on an upper end portion of the first protrusion 311. In this case, the height t is a straight distance from an inner end to an outer end of the first protrusion 311 in the radial direction of the stator 300.

Since the corresponding region P is hooked on the inner surface of the housing 500 so that slip occurring between the stator 300 and the housing 500 in an axial direction is prevented, the stator 300 is prevented from moving in the housing 500.

In the embodiment, the example of the motor including the busbar has been described, but the present invention is not limited thereto and may be applied to a motor which does not include a busbar. In addition, the present invention may be used in various devices for vehicles, home appliances, or the like.

1. A motor comprising:
a rotor;
a stator disposed to correspond to the rotor; and
a housing disposed outside the stator,
wherein the stator includes a stator core, an insulator disposed on the stator core, and a coil disposed around the insulator,
wherein the stator core includes a yoke and a tooth connected to the yoke,
wherein the yoke includes one surface, a first protrusion protruding from the one surface of the yoke, and a first groove formed in the one surface of the yoke,
wherein the housing includes a second surface facing the one surface of the yoke, a second protrusion protruding from the second surface of the housing, and a second groove formed in the second surface of the housing,
wherein at least a part of the first protrusion is disposed in the second groove,
wherein a predetermined gap is formed between the one surface of the yoke and the ether second surface of the housing,
wherein one surface of the first protrusion and one surface of the first groove are connected to each other, and
wherein at least a part of the first protrusion is disposed in the second groove.

2-3. (canceled)

4. The motor of claim 1, wherein a width of the first protrusion in a circumferential direction is in a range of 150% to 170% of a width of the second groove in the circumferential direction.

5. The motor of claim 1, wherein one surface of the first protrusion is in contact with one surface of the second protrusion.

6. The motor of claim 1, wherein at least apart of the second protrusion is disposed in the first groove.

7. The motor of claim 1, wherein:
a volume of the second groove and a volume of the second protrusion are the same; and
a volume of the first groove and a volume of the first protrusion are the same.

8. The motor of claim 1, wherein:
the housing includes a third protrusion protruding from an inner surface of the housing; and
the second groove is disposed between the second protrusion and the third protrusion in a circumferential direction.

9. The motor of claim 8, wherein a volume of the second groove is the same as a sum of a volume of the second protrusion and a volume of the third protrusion.

10. A motor comprising:
a rotor;
a stator disposed to correspond to the rotor; and
a housing disposed outside the stator,
wherein the stator includes a stator core, an insulator disposed on the stator core, and a coil disposed around the insulator,
wherein the stator core includes a yoke and a tooth connected to the yoke,
wherein the yoke includes one surface, a first protrusion protruding from the one surface of the yoke, and a first groove formed in the one surface of the yoke,
wherein the housing includes a second surface facing the one surface of the yoke and a stepped portion protruding from the second surface of the housing, and
wherein the stepped portion includes a third groove in which at least a part of the first protrusion is disposed.

11. The motor of claim 1, wherein the yoke includes a groove at a position overlapping the tooth in a radial direction, and the first protrusion and the first groove are disposed at one side or both sides of the groove.

12. The motor of claim 11, wherein the first protrusion and the first groove are disposed at both sides of the groove and have same distances from the groove.
